(19) United States
(12) Patent Application Publication
(10) Pub. No.: US 2010/0231628 A1
(43) Pub. Date: Sep. 16, 2010

(54) LIQUID-EJECTING APPARATUS AND METHOD OF CONTROLLING DRIVING OF LIQUID-EJECTING APPARATUS

(75) Inventor: Kenji TSUKADA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/722,358

(22) Filed: Mar. 11, 2010

(30) Foreign Application Priority Data
Mar. 12, 2009 (JP) 2009-059049

(51) Int. Cl. B41J 2/07; B41J 29/38

(52) U.S. Cl. 347/14

(57) ABSTRACT

A liquid-ejecting apparatus includes: a liquid-ejecting head that is capable of ejecting a liquid from a nozzle opening; a liquid-receiving unit that is capable of receiving the liquid ejected from the liquid-ejecting head; a driving unit that provides driving power that causes the liquid-ejecting head to operate; and a controller that calculates a waiting time in accordance with an amount of liquid ejected during a flushing operation, in which the liquid-ejecting head ejects the liquid into the liquid-receiving unit, and performs control so as to cause the driving unit to perform driving once the calculated waiting time has elapsed.

This application claims the benefit of Japanese Patent Application No. 2009-059049, filed Mar. 12, 2009, which is expressly incorporated herein by reference in its entirety.

### BACKGROUND

1. Technical Field

The present invention relates to a liquid-ejecting apparatus and a method of controlling driving of a liquid-ejecting apparatus.

2. Related Art

In general, ink jet printers eject ink droplets from a print head and thereby cause the ink droplets to adhere to a printing medium such as a paper sheet. In printers of this type, an operation called flushing, in which ink droplets are ejected for a purpose other than that of a printing operation, is performed before initiation of or during a printing operation in order to prevent defective ejection of ink due to an increase in the viscosity of the ink. However, a problem arises in that when a flushing operation is performed, a fine mist, also referred to as satellite ink droplets for example, forms when ink droplets fly out of the nozzles and this fine mist adheres to a linear scale or the like in the printer.

In relation to this, JP-A-2007-30478 discloses a technique for determining a waiting time on the basis of paper size information in the case where a flushing operation has been performed during a printing operation, the carriage not being driven during the waiting time.

The technique disclosed in JP-A-2007-30478 relates to the determination of a waiting time in the case where a flushing operation has been performed during a printing operation. Consequently, no consideration is made of cases where a large amount of ink droplets are ejected in the flushing operation, such as in a flushing operation carried out before initiation of a printing operation. Furthermore, in a flushing operation performed before initiation of a printing operation, a large amount of mist is generated and therefore the large amount of generated mist adheres to for example a linear scale inside the printer and causes reading errors in a linear encoder or the like.

Furthermore, in the technique disclosed in JP-A-2007-30478, the waiting time is fixed once the size of the paper sheet has been determined. However, dispersion of a mist cannot be effectively prevented using only the technique disclosed in JP-A-2007-30478 since ink droplets are ejecting in a differing amount in a flushing operation performed prior to initiation of a printing operation, compared with a flushing operation performed during a printing operation.

### SUMMARY

Some aspects of the invention are advantageous in that a liquid-ejecting apparatus and a method of controlling driving of a liquid-ejecting apparatus are provided that are capable of calculating a waiting time in accordance with a flushing amount and effectively preventing dispersion of a mist into the interior of the apparatus.

A liquid-ejecting apparatus according to a first aspect of the invention includes a liquid-ejecting head that is capable of ejecting a liquid from a nozzle opening; a liquid-receiving unit that is capable of receiving the liquid ejected from the liquid-ejecting head; a driving unit that provides a driving power that causes the liquid-ejecting head to operate; and a controller that calculates a waiting time in accordance with an amount of liquid ejected during a flushing operation, in which the liquid-ejecting head ejects the liquid into the liquid-receiving unit, and performs control so as to cause the driving unit to perform driving once the calculated waiting time has elapsed.

Furthermore, in the liquid-ejecting apparatus according to the first aspect of the invention, the controller preferably calculates the waiting time when the flushing operation is performed before performance of a continuous ejection operation in which the liquid is ejected onto an ejection target, and performs control so as to cause the driving unit to perform driving once the waiting time has elapsed.

Furthermore, in the liquid-ejecting apparatus according to the first aspect of the invention, the controller preferably calculates the waiting time when the flushing operation is performed after the liquid has been forcibly ejected from the liquid-ejecting head by suction.

Furthermore, in the liquid-ejecting apparatus according to the first aspect of the invention, a relation between the amount of liquid ejected during the flushing operation and the waiting time preferably forms a linear function and the controller preferably calculates the waiting time from the amount of liquid ejected on the basis of the linear function.

Furthermore, in the liquid-ejecting apparatus according to the first aspect of the invention, in the case where the amount of liquid ejected during the flushing operation is equal to or larger than a predetermined amount, a relation between the amount of liquid ejected during the flushing operation and the waiting time preferably forms a linear function and in the case where the amount of liquid ejected during the flushing operation is less than a predetermined amount, the waiting time preferably takes a minimum value independently of the amount of liquid ejected during the flushing operation.

Furthermore, in the liquid-ejecting apparatus according to the first aspect of the invention, the controller preferably performs control so as to change a slope of the linear function on the basis of an accumulative usage condition of the liquid-ejecting apparatus.

Furthermore, in the liquid-ejecting apparatus according to the first aspect of the invention, the controller preferably uses, as a measure of the amount of liquid ejected during the flushing operation, a value calculated by summing together the amounts of different liquids ejected from the liquid-ejecting head to obtain a total value and dividing the total value by the number of different liquids.

Furthermore, a method of controlling driving of a liquid-ejecting apparatus according to a second aspect of the invention, the liquid-ejecting apparatus having a liquid-ejecting head that is capable of ejecting a liquid from a nozzle opening, a liquid-receiving unit that is capable of receiving the liquid ejected from the liquid-ejecting head, a driving unit that provides a driving power that causes the liquid-ejecting head to operate, includes: performing a flushing operation in which the liquid-ejecting head ejects the liquid into the liquid-receiving unit; calculating a waiting time in accordance with an amount of liquid ejected during the flushing operation; and controlling driving of the liquid-ejecting apparatus so as to cause the driving unit to perform driving once the calculated waiting time has elapsed.

### BRIEF DESCRIPTION OF THE DRAWINGS

The invention will be described with reference to the accompanying drawings, wherein like numbers reference like elements.

FIG. 1 is a perspective view illustrating the configuration of a printer according to an embodiment of the invention.

FIG. 2 is a diagram illustrating an overview of the configuration of the printer illustrated in FIG. 1.

FIG. 3 is a diagram illustrating an overview of the configuration of a cleaning mechanism of the printer illustrated in FIG. 1.

FIG. 4 is a block diagram illustrating an overview of the configuration of a controller of the printer illustrated in FIG. 1.

FIG. 5 is a diagram illustrating a relation between the number of shots used during a flushing operation and a waiting time.

FIG. 6 is a diagram illustrating the formation of an ink droplet and satellite ink droplets (mist).

FIG. 7 is a diagram illustrating a relation between the number of shots used during a flushing operation and the waiting time.

### DESCRIPTION OF EXEMPLARY EMBODIMENTS

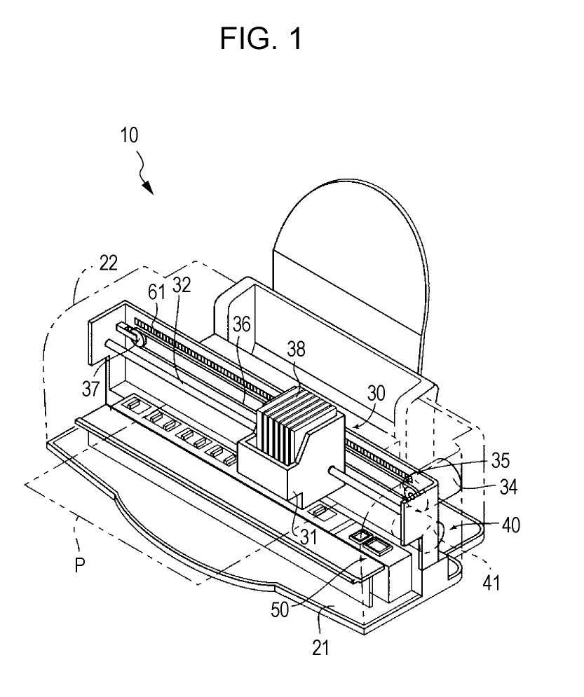

Hereafter, a printer 10 according to an embodiment of the invention will be described with reference to FIGS. 1 to 6, the printer 10 being an example of the liquid-ejecting apparatus according to the first aspect of the invention. In the following description, the term “lower side” indicates a surface side on which the printer 10 is installed for use and the term “upper side” indicates a side separated from the lower side. Furthermore, a direction in which a carriage 31 moves will be referred to as a main scanning direction and a direction in which a printing target P is transported and which is orthogonal to the main scanning direction will be referred to as a sub-scanning direction. A side from which the printing target P is supplied will be referred to as a paper-supply side and a side from which the printing target P is ejected will be referred to as a paper-ejection side.

### Overview of Configuration of Printer

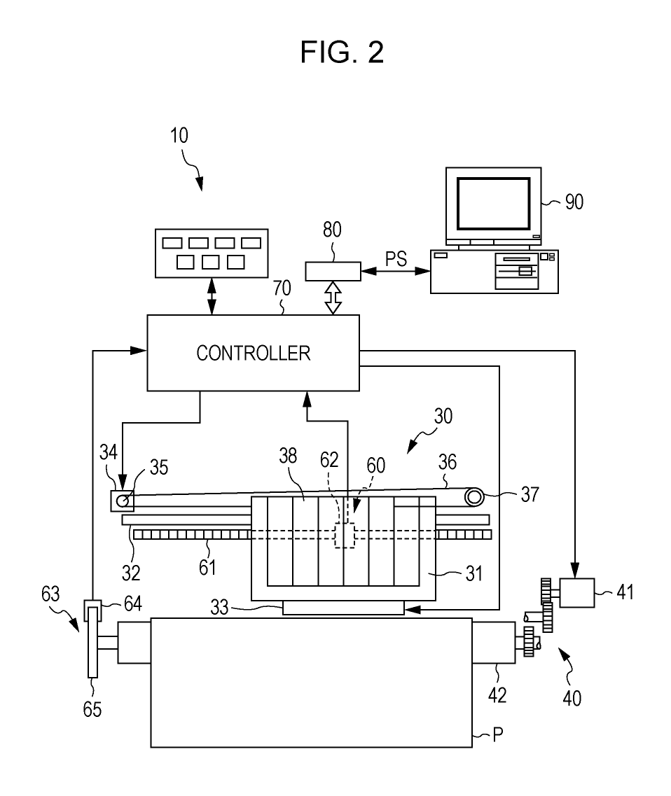

First, an overview of the configuration of the printer 10 will be described. FIG. 1 is a perspective view that illustrates an overview of the configuration of the printer 10 according to the embodiment of the invention and in which the sheet-ejection side is arranged at the top and the sheet-supply side is arranged at the bottom. Furthermore, FIG. 2 illustrates an overview of the configuration of the printer 10. The printer 10 of the embodiment of the invention includes a chassis 21, a housing 22, a carriage mechanism 30, a paper-feeding mechanism 40, a cleaning mechanism 50 and a controller 70.

Among these components, the chassis 21 is a component whose lower surface is in contact with an installation surface and in which various other components are mounted. Furthermore, the housing 22, which is illustrated by a two-dot dashed line in FIG. 1, is attached to the chassis 21. The housing 22 has a similar shape to the above-described chassis 21 in plan view.

In addition, as illustrated in FIGS. 1 and 2, the carriage mechanism 30 includes a carriage 31, a carriage shaft 32 along which the carriage 31 slides, and a print head 33 (corresponding to the liquid-ejecting head, refer to FIG. 2). Moreover, the carriage mechanism 30 also includes a carriage motor 34 (CR motor, corresponding to the driving unit), a gear pulley 35 attached to the CR motor 34, an endless belt 36 and a driven pulley 37, the endless belt 36 being stretched over the gear pulley 35 and the driven pulley 37.

In addition, an ink cartridge 38, which stores for example black, yellow, cyan, and magenta inks is mounted on the carriage 31 and ink is supplied from the ink cartridge 38 to the print head 33.

In this embodiment, pigment inks are used as inks. However, the embodiment of the invention may be applied to dye inks. In addition, in FIG. 1, the printer 10 is illustrated as being a so-called on-carriage type printer in which the ink cartridge 38 is mounted on the carriage 31. However, the printer 10 is not limited to being an on-carriage type printer and the printer 10 may instead be a so-called off-carriage type printer in which the ink cartridge is instead mounted on the chassis 21 of the printer 10. In addition, the number of colors of the ink cartridge 38 is not limited to the four colors of black, yellow, cyan and magenta described above and may be one or two colors, three colors of yellow, cyan and magenta, or five or more colors.

In addition, as illustrated in FIG. 2, the paper-feeding mechanism 40 includes a paper-feeding motor (PF motor) 41 and a paper-feeding roller 42 to which driving power is conveyed from the PF motor 41.

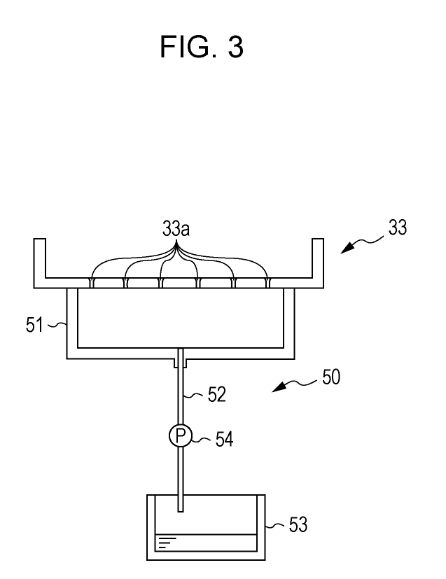

Furthermore, the cleaning mechanism 50, as illustrated in FIG. 3, is installed on the chassis 21. The cleaning mechanism 50 includes a cap 51, an ink ejection tube 52, a waste ink tank 53 and a suction pump 54.

Among these components, the cap 51 corresponds to the liquid-receiving unit of the first aspect of the invention and is a component that seals nozzles 33a (refer to FIG. 3 etc.) of the print head 33 from the outside. In order to do this, the cap 51 can be moved up and down by an elevating mechanism, which is not illustrated in the figures. Furthermore, one end of the ink ejection tube 52 is connected to the cap 51 and the other end of the ink ejection tube 52 is connected to the waste ink tank 53. The waste ink tank 53 accumulates ink ejected into the cap 51 from the nozzles 33a of the print head 33. In addition, the suction pump 54 is connected to a central portion of the ink ejection tube 52. Accordingly, when the suction pump 54 operates, ink can be ejected into the waste ink tank 53 from the nozzles 33a.

Furthermore, as illustrated in FIGS. 1 and 2, the printer 10 includes a linear encoder 60. The linear encoder 60 has a linear scale 61 (refer to FIG. 1), which consists of a repeating line pattern of a black printed portion and a transparent portion through which light passes, and a linear sensor 62 that emits light toward the linear scale 61, converts light reflected by the linear scale 61 into an electrical signal (encoder signal) and sends the encoder signal to the controller 70. In addition to the linear encoder 60, the printer 10 also includes a rotary encoder 63 for detecting a paper feeding amount and the rotary encoder 63 includes a rotary scale 64 and a rotary sensor 65. However, description of the configuration of the rotary encoder 63, other than the fact that the rotary scale 64 has a discoidal shape, is omitted, since it is similar to that of the linear encoder 60.

### Configuration of Controller

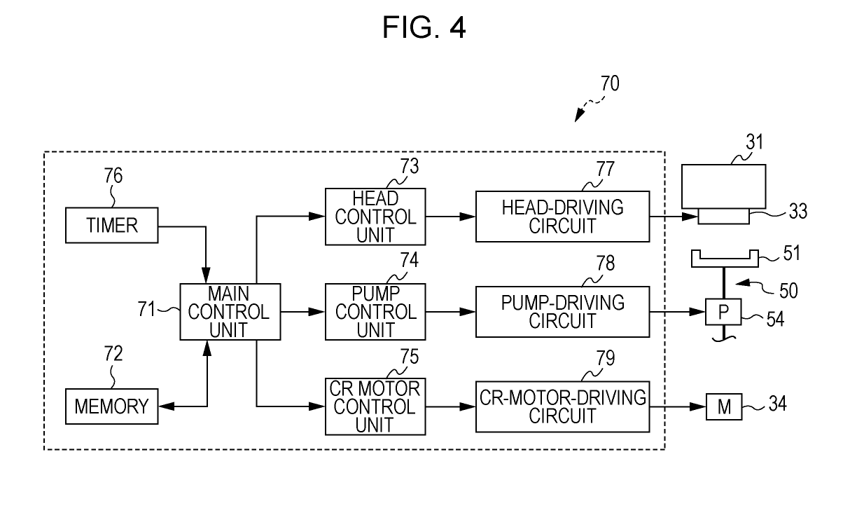

Furthermore, as illustrated in FIGS. 2 and 4, the printer 10 is provided with the controller 70. The controller 70 has a CPU, which is not illustrated, a memory 72 such as a non-volatile memory such as a ROM, or a RAM or the like, an application specific integrated circuit (ASIC), a bus, a timer 76, an interface 80 and the like. The above-described controller 70 corresponds to the controller of the first aspect of the invention.

Furthermore, signals from various sensors such as the linear sensor 62 and the rotary sensor 65 are input to the controller 70 and the controller 70 governs driving of the CR motor 34, PF motor 41, the suction pump 54, the print head 33 and the like on the basis of the signals from these sensors.

In addition, data and a program stored in the above-described memory are executed by the CPU and a configuration such as that illustrated in the block diagram of FIG. 4 is functionally realized by cooperation of the individual components of the controller 70. As illustrated in FIG. 6, the controller 70 includes a main control unit 71, the memory 72, a head control unit 73, a pump control unit 74, a CR motor control unit 75, a timer 76, a head-driving circuit 77, a pump-driving circuit 78 and a CR-motor-driving circuit 79.

Among these components, the main control unit 71 is a component that governs control of the entirety of the printer 10 and receives inputs of for example commands from a computer 90 and timing signals output from the timer 76 and reads a control program and various data stored in the memory 72 thereinto. Furthermore, the main control unit 71 determines whether initiation of printing has been performed in a predetermined printing mode on the basis of a command (printing signal) from the computer 90 or an operation performed by the user on the printer 10. The main control unit 71, prior to initiation of printing, instructs the head control unit 73 to perform a flushing operation, as described later, and then instructs the CR motor control unit 75 not to drive the CR motor 34 until a predetermined waiting time has elapsed from completion of the flushing operation.

In addition, various control programs and various data are stored in the memory 72. Furthermore, the head control unit 73 drives the print head 33 through the head-driving circuit 77 on the basis of a command from the main control unit 71 and thereby ink droplets are ejected. Here, a command to perform printing on the basis of print data and a command to perform flushing, which is one type of maintenance operation, are examples of commands that the head control unit 73 receives from the main control unit 71.

Furthermore, the pump control unit 74 controls driving of the suction pump 54 through the pump-driving circuit 78, in a state in which the print head 33 has been sealed by the cap 51, and performs a predetermined cleaning operation on the basis of commands from the main control unit 71. In addition, the CR motor control unit 75 drives the CR motor 34 through the CR-motor-driving circuit 79 on the basis of a command from the main control unit 71. Furthermore, in the case where printing is to be performed, the CR motor control unit 75 drives the CR motor 34 in synchronization with operation of the print head 33. In the case where a flushing operation is to be performed or in the case where a cleaning operation is to be performed by driving the suction pump 54, the CR motor control unit 75 drives the CR motor 34 prior to flushing of the print head 33 and moves the carriage 31 toward the cap 51.

In addition, the timer 76 keeps track of time by counting cycles of a clock signal, which is not illustrated. When the timer 76 determines that a time, which has been set in advance, has elapsed (a set waiting time, which is a time to be waited after completion of the above-described flushing operation) on the basis of the counting performed thereby, the timer 76 outputs a signal indicating that the set time has elapsed (e.g., a timer interrupt signal) to the main control unit 71.

In addition, the head-driving circuit 77 generates a predetermined voltage in response to a command from the head control unit 73 and applies the voltage to a piezoelectric element within the print head 33. Furthermore, the CR-motor-driving circuit 79 generates a predetermined voltage in response to a command from the CR motor control unit 75 and applies the voltage to the CR motor 34.

The controller 70 is connected to the computer 90 through the interface 80 and is capable of sending and receiving various data such as print data. In addition, the computer 90 may be configured so as to have the same function as the above-described controller 70.

### Operation of Printer

Hereafter, operation of the printer 10 will be described. In the case where a printing operation of the printer 10 is to be initiated, prior to initiation of the printing operation, the printer 10 performs a flushing operation. Accordingly, the main control unit 71 outputs a command to the CR motor control unit 75. In response to this command, the CR motor control unit 75 drives the CR motor 34 so as to position the print head 33 in an upper portion of the cap 51, prior to performance of the flushing operation. Thus, the print head 33 is positioned in the upper portion of the cap 51.

In this state, the main control unit 71 outputs a command to the head control unit 73 so as to perform a flushing operation. In response to this command, the head control unit 73 drives the print head 33 and ink droplets are ejected in exactly a predetermined number of shots. As a result, ink droplets are ejected from the nozzles 33a and travel toward the bottom of the cap 51.

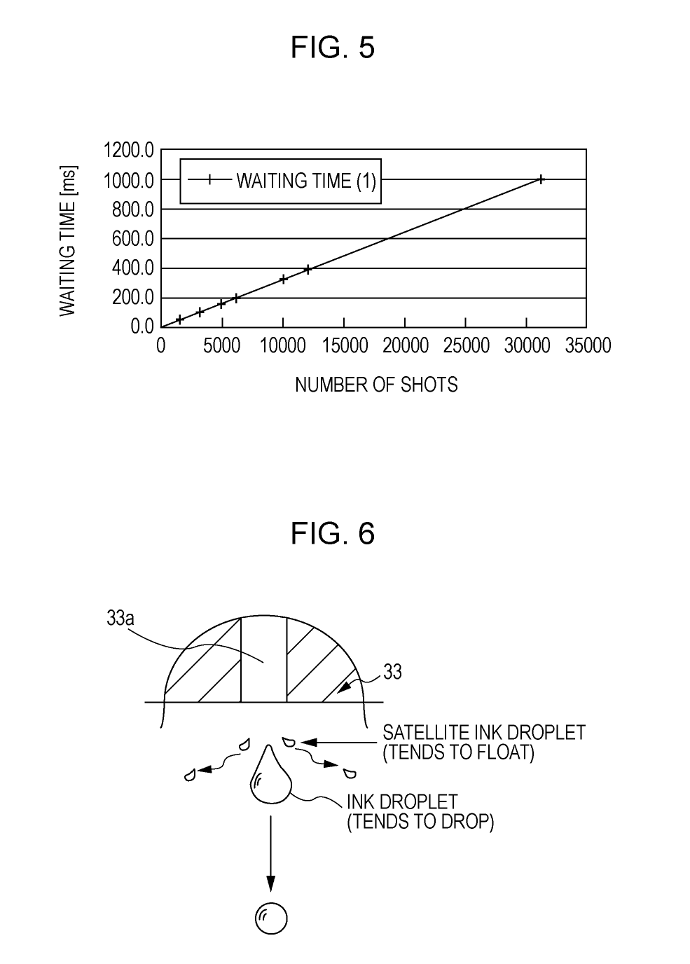

Here, when ejection of the ink droplets is to be performed, the main control unit 71 calculates a waiting time to be waited after a flushing operation has been performed. The waiting time is calculated on the basis of the graph illustrated in FIG. 5. In the graph illustrated in FIG. 5, the horizontal axis represents the number of shots used during a flushing operation and the vertical axis represents the waiting time, which is the time to be waited after completion of the flushing operation. Here, the number of shots is the averaged number of shots from rows of the nozzles 33a (nozzle rows) of individual colors. For example, when the nozzles rows are divided into four colors of cyan, yellow, magenta and black, in order to calculate the waiting time, the average number of shots per nozzle is calculated by summing together the numbers of shots for the nozzles 33a of the respective colors and then dividing the obtained value by the total number of nozzles.

The relation illustrated in FIG. 5 between the number of shots used during a flushing operation and the waiting time to be waited after completion of the flushing operation can be obtained in advance by experimentation or the like.

In addition, the graph illustrated in FIG. 5 represents a linear expression that provides a waiting time of 1 s (100 ms) when the number of shots is 31159. More specifically, the waiting time is calculated by using the following linear expression: waiting time (ms)=(number of shots/31159)×1000). Accordingly, provided that the number of shots used during the flushing operation is ascertained at the time of a flushing operation from for example a command from the main control unit 71 or the count of, for example, a counter that counts cycles of the waveform of the driving signal of the print head 33, not illustrated, the main control unit 71 can arithmetically calculate the waiting time. The waiting time is calculated as described above.

Next, the main control unit 71 outputs a command to the CR motor control unit 75 so as to cause the CR motor 34 to operate once the waiting time after completion of the flushing operation has elapsed as counted by the timer 76. As a result, in the interior of the cap 51, a large amount of mist adheres to the inner wall of the cap 51 during a period up until the waiting time elapses.

FIG. 6 is a diagram that illustrates the formation of mist. As illustrated in FIG. 6, when an ink droplet is ejected, the ink droplet moves away from the edge of the opening of the nozzle 33a, separates into pieces and a mist, also known as satellite ink droplets, is formed that is composed of droplets much smaller than the droplet. The mist (satellite ink droplets) tends to float in the air because of the extremely small size of the droplets forming the mist. Consequently, if the carriage 31 (print head 33) is moved in the main scanning direction as a result of the CR motor 34 being operated before the waiting time has elapsed, an air current is generated by the movement and the mist is blown along by the air current.

Thereafter, the blown mist adheres to certain locations within the interior of the printer 10. An example of such locations is on the linear scale 61. If a large amount of the mist adheres to the linear scale 61, light emitted from the linear sensor 62 cannot pass through the transparent portions of the linear scale 61 and this leads to a state in which the linear encoder 60 makes reading errors.

In contrast, in this embodiment, as described above, in the CR motor control unit 75, the calculated waiting time is allowed to elapse from the end of the flushing operation in accordance with a command from the main control unit 71. Then, once the waiting time has elapsed, the CR motor 34 is operated and printing is initiated.

In the above-described operation, the greater the number of shots used in the flushing operation, that is, the larger the amount of mist generated is, the longer the waiting time becomes. Consequently, the period of time during which the mist is allowed to settle in the interior of the cap 51 in which there is substantially no airflow can be increased and a large amount of the mist can be allowed to adhere to the interior of the cap 51. Accordingly, the amount of mist that is blown into the interior of the printer 10 after operation of the CR motor 34 (after the carriage 31 is moved) is advantageously reduced.

### ADVANTAGE OF INVENTION

According to the printer 10, a predetermined waiting time calculated by the main control unit 71 is allowed to elapse after completion of a flushing operation before the CR motor 34 is operated. Accordingly, the mist can be allowed to adhere to the interior of the cap 51 in which there is substantially no air current. As a result, dispersion of the mist can be advantageously suppressed in the case where the CR motor 34 is driven after completion of a flushing operation.

In particular, in this embodiment, the waiting time is calculated by the main control unit 71 on the basis of the number of shots used during a flushing operation. Here, the greater the number of shots used is, the more the amount of mist increases, and since the waiting time becomes long in such a case, the majority of the mist can be allowed to adhere to the interior of the cap 51. Therefore, dispersion of the mist can be advantageously suppressed in the case where the CR motor 34 is driven after completion of a flushing operation.

Furthermore, as described above, the CR motor 34 is driven once the waiting time has elapsed, and therefore dispersion of at least a certain amount of mist into the interior of the printer 10 can be prevented. Consequently, the linear encoder 60 can be advantageously prevented from making reading errors and the service life of the printer 10 can be extended.

In addition, in this embodiment, when performing a flushing operation prior to initiation of printing, a waiting time is calculated by the main control unit 71 and the CR motor 34 is driven once the waiting time has elapsed. Accordingly, at times when a great number of shots have been used during the flushing operation (i.e., times prior to initiation of a printing operation), the CR motor 34 is driven after the waiting time has elapsed, and therefore dispersion of mist into the interior of the printer 10 can be more advantageously prevented.

Furthermore, in this embodiment, the relation between the number of shots used during a flushing operation and the waiting time forms a linear function as illustrated in FIG. 5 and the main control unit 71 calculates the waiting time from the number of shots determined to have been used during flushing by using the expression represented by the linear function illustrated in FIG. 5.

Therefore, in addition to calculation of the waiting time being simple, provided that the relation between the determined number of shots and the waiting time is known, the waiting time can be easily calculated for any given number of shots.

In addition, in this embodiment, in the case where the number of shots used during a flushing operation is calculated by the main control unit 71, a value obtained by summing together all of the numbers of shots of inks of respective colors and then dividing this total by the total number of nozzles (i.e., an average value) is used. By performing the above-described calculation, the number of reading errors that occur in the linear encoder 60 can be made to directly correspond to the number of shots used during flushing. That is, reading errors in the linear encoder 60 occur due to adhesion of mist to the transparent portions of the linear scale 61 and the degree to which the transparent portions, to which the mist has adhered, block light, does not vary significantly with color. Consequently, in the case where an average value is used as described above, the number of shots used during a flushing operation directly corresponds to the occurrence of reading errors in the linear encoder 60. Thus, provided that the waiting time is calculated using the relation between the number of shots and the waiting time of FIG. 5 as described above, dispersion of mist into the interior of the printer 10 can be advantageously prevented.

### Modifications of Embodiment of Invention

Although description has been given of an embodiment of the invention above, the embodiment of the invention can be modified in various ways as will be described below.

In the above-described embodiment of the invention, once the calculated waiting time has elapsed, the CR motor 34 is caused to immediately operate and printing is initiated. However, the CR motor 34 may instead be caused to operate once a period of time longer than the calculated waiting time has elapsed. In the case where the CR motor 34 is caused to operate once a period of time longer than the calculated waiting has elapsed, an even greater amount of the mist can be allowed to adhere to the interior of the cap 51 and dispersion of the mist into the interior of the printer 10 can be even more advantageously prevented. However, in this case, since the period of time until printing is initiated becomes long, it is desirable that the period of time does not become so long as to annoy the user.

In addition, in the above-described embodiment, in the case where the main control unit 71 performs flushing at a timing prior to initiation of printing, the main control unit 71 calculates the waiting time, waits for the waiting time to elapse and then causes the CR motor 34 to operate. However, the timing at which the CR motor 34 is caused to operate once the waiting time has elapsed after completion of the flushing operation is not limited to a timing prior to initiation of printing. For example, a cleaning operation may be performed by operating the suction pump 54 during a printing operation.

To be more specific, ink is not ejected from all nozzles during a printing operation, but rather there are some nozzles from which ink is not ejected. In order to prevent the viscosity of ink in part of the nozzle openings of nozzles that continue to be in a state of not ejecting ink from increasing, flushing is periodically performed during a printing operation (known as periodic flushing). The sizes of ink droplets ejected from nozzles during a printing operation differ depending on the type of image being printed and the degree to which the accuracy with which ink droplets are ejected is affected by the increase in viscosity of ink in part of a nozzle opening is greater in the case where small ink droplets are ejected than in the case where large ink droplets are ejected. Therefore, the number of shots to be used during periodic flushing differs depending on the on the type of image being printed.

Accordingly, in the case where periodic flushing is to be performed, the waiting time is calculated and then control may be performed such that the CR motor 34 is driven once the calculated waiting time has elapsed.

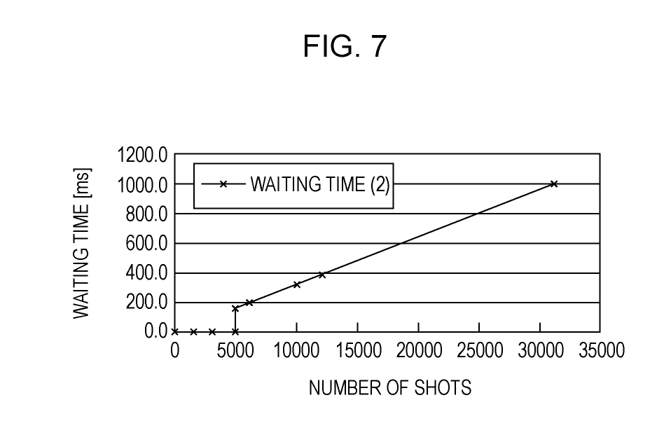

Furthermore, in the above-described embodiment, in the case where the waiting time is calculated by using the determined number of shots, the waiting time is calculated on the basis of a linear function such as that illustrated in FIG. 5. However, the waiting time may be calculated on the basis of something other than a linear function such as that illustrated in FIG. 5. For example, the waiting time may be calculated on the basis of the graph illustrated in FIG. 7. As illustrated in FIG. 7, in the case where the number of shots used in a flushing operation is under a predetermined threshold (less than a predetermined number), the waiting time is determined so as to be zero, which is the minimum value of the waiting time. In FIG. 7, the number of shots that corresponds to the predetermined number is 5000.

In FIG. 7, in the case where the number of shots is small (i.e., less than 5000), the waiting time becomes the minimum value, such as zero. This is because when the number of shots used in a flushing operation is small, only a very small amount of mist is generated. A further reason for this is that in the case where the number of shots is small, the degree to which the amount of mist is further reduced is not significantly different from when the waiting time is zero because the waiting time is very short.

Furthermore, with this modification, since the waiting time is long when the number of shots is large, mist can be effectively prevented from being dispersed into the interior of the printer 10. The minimum value is not limited to being zero and while any value equal to or greater than zero may serve as the waiting time, it is preferable that the minimum value be smaller than the waiting time in the case where the predetermined amount is calculated using the linear function.

Furthermore, rather than calculating the waiting time by using a linear function as illustrated in FIGS. 5 and 7, the waiting time may be calculated by using an nth-order function such as a quadratic function, an exponential function, a logarithmic function, a trigonometric function, a predetermined inverse function, or any combination thereof.

In addition, in the above-described embodiment, the slope of the linear function illustrated in FIG. 5 is constant. However, control may be performed such that the slope of the linear function is changed on the basis of accumulated conditions of use of the printer 10. Here, examples of values that indicate the accumulated conditions of use include the number of printed pages, the printing time, the accumulated use time, and the number of times cleaning has been performed. These values become larger as the end of the service life of the printer 10 approaches, and therefore the slope of the linear function can be increased so that it can be ensured that the occurrence of dispersion of mist into the interior of the printer 10 is suppressed as much as possible.

In addition, in the above-described embodiment, the printer 10 was described as being a so-called on-carriage-type printer in which the ink cartridge 38 is mounted on the carriage 31. However, the printer 10 is not limited to being an on-carriage-type printer and may instead be a so-called off-carriage-type printer in which the ink carriage 38 is mounted on the chassis 21 of the printer 10.

Furthermore, in the above-described embodiment, the cap 51 was described as being used as the liquid receiving unit of the first aspect of the invention. However, the liquid-receiving unit is not limited to being the cap 51 and may instead be a flushing box dedicated to flushing. In the case where such a flushing box is used as the liquid-receiving unit, an embodiment of the invention is realized in which the flushing box is provided so as to oppose the nozzle opening side of the print head 33 in close contact therewith. In addition, even in the case where the cap 51 is used as the liquid-receiving unit, an embodiment of the invention is realized in which the cap 51 closely contacts the nozzle opening side of the print head 33 with no gap therebetween.

In addition, the printer 10 of the above-described embodiment, serving as an example of the liquid-ejecting apparatus according the first aspect of the invention, may be just one part of a multifunction apparatus having not only the function of a printer but also functions of a scanner, a copier and the like. Furthermore, in the above-described embodiment of the invention, the printer 10 was described as being an ink jet printer. However, the printer 10 is not limited to being an ink jet printer and may be another type of printer provided that the printer 10 is capable of ejecting a fluid. For example, an embodiment of the invention can be applied to various types of printer including, for example, a gel jet printer, a toner printer and a dot impact printer.

In addition, although a liquid-ejecting apparatus is embodied as the ink jet printer 10 in the above-described embodiment, instead of the liquid-ejecting apparatus, any of the following may be embodied instead: a liquid-material-ejecting apparatus that ejects a fluid including a material such as an electrode material or a color material (pixel material), which is used in for example the manufacture of liquid crystal displays, electrophoretic (EL) displays and flat light-emitting displays, in the form of a dispersion or solution; a fluid-ejecting apparatus that ejects a fluid other than a liquid such as living organic matter used in the manufacture of biochips; and a fluid-ejecting apparatus that is used as a precision pipette and ejects a fluid serving as a sample.

Furthermore, the liquid-ejecting apparatus may be a liquid-ejecting apparatus that ejects a lubricating oil into precision mechanisms such as those of watches and cameras, a liquid-ejecting apparatus that ejects a transparent liquid resin, such as an ultraviolet curable resin, onto a substrate to form for example minute semi-spherical lenses (optical lenses) used in optical communication devices or the like, a liquid-ejecting apparatus that ejects an etching liquid such as an acid or an alkyl in order to etch a substrate or the like, or, instead of a liquid-ejecting apparatus, may be a fluid-material-ejecting apparatus that ejects a fluid material such as a gel (for example, a physical gel). Embodiments of the invention can be applied to any of the above types of liquid-ejecting apparatuses (or fluid-ejecting apparatuses).

What is claimed is:

1. A liquid-ejecting apparatus comprising:
a liquid-ejecting head that is capable of ejecting a liquid from a nozzle opening;
a liquid-receiving unit that is capable of receiving the liquid ejected from the liquid-ejecting head;
a driving unit that provides driving power that causes the liquid-ejecting head to operate; and
a controller that calculates a waiting time in accordance with an amount of liquid ejected during a flushing operation, in which the liquid-ejecting head ejects the liquid into the liquid-receiving unit, and performs control so as to cause the driving unit to perform driving once the calculated waiting time has elapsed.

2. The liquid-ejecting apparatus according to claim 1, wherein, the controller calculates the waiting time when the flushing operation is performed before performance of a continuous ejection operation in which the liquid is ejected onto an ejection target, and performs control so as to cause the driving unit to perform driving once the waiting time has elapsed.

3. The liquid-ejecting apparatus according to claim 1, wherein, the controller calculates the waiting time when the flushing operation is performed after the liquid has been forcibly ejected from the liquid-ejecting head by suction.

4. The liquid-ejecting apparatus according to claim 1, wherein a relation between the amount of liquid ejected during the flushing operation and the waiting time forms a linear function and the controller calculates the waiting time from the amount of liquid ejected on the basis of the linear function.

5. The liquid-ejecting apparatus according to claim 1, wherein, in the case where the amount of liquid ejected during the flushing operation is equal to or larger than a predetermined amount, a relation between the amount of liquid ejected during the flushing operation and the waiting time forms a linear function and in the case where the amount of liquid ejected during the flushing operation less than a predetermined amount, the waiting time takes a minimum value independently of the amount of liquid ejected during the flushing operation.

6. The liquid-ejecting apparatus according to claim 4, wherein the controller performs control so as to change a slope of the linear function on the basis of an accumulative usage condition of the liquid-ejecting apparatus.

7. The liquid-ejecting apparatus according to claim 1, wherein the controller uses, as a measure of the amount of liquid ejected during the flushing operation, a value calculated by summing together the amounts of different liquids ejected from the liquid-ejecting head to obtain a total value and dividing the total value by the number of different liquids.

8. A method of controlling driving of a liquid-ejecting apparatus, which includes a liquid-ejecting head that is capable of ejecting a liquid from a nozzle opening, a liquid-receiving unit that is capable of receiving the liquid ejected from the liquid-ejecting head, a driving unit that provides a driving power that causes the liquid-ejecting head to operate, the method comprising:
performing a flushing operation in which the liquid-ejecting head ejects the liquid into the liquid-receiving unit;
calculating a waiting time in accordance with an amount of liquid ejected during the flushing operation; and
controlling driving of the liquid-ejecting apparatus so as to cause the driving unit to perform driving once the calculated waiting time has elapsed.
